(19) United States
(12) Patent Application Publication
(10) Pub. No.: US 2014/0129573 A1
(43) Pub. Date: May 8, 2014

(54) COMPUTERIZED METHOD AND SYSTEM FOR CREATING A DIGITAL RESUME

(71) Applicant: Daniel Jacobus deWaal, Reno, NV (US)

(72) Inventor: Daniel Jacobus deWaal, Reno, NV (US)

(21) Appl. No.: 13/768,388

(22) Filed: Feb. 15, 2013

Related U.S. Application Data
(60) Provisional application No. 61/723,261, filed on Nov. 6, 2012.

(51) Int. Cl. G06F 17/30

(52) U.S. Cl. CPC G06F 17/3053; H04L 51/32
USPC 707/751; 709/204; 707/769

(57) ABSTRACT

A system and computer-implemented method to build a digital resume which may incorporate work history data as well as reviews by former co-workers, and may further include a computer generated status of the digital resume.

### PRIORITY CLAIM

This application claims priority to and the benefit of U.S. provisional patent application Ser. No. 61/723,261 filed Nov. 6, 2012, the entire contents of which is incorporated herein by reference.

### BACKGROUND

The past few decades have heralded a wave of technological developments that have served to greatly empower the individual. Personal computers, mobile phones, and the internet are all unique but closely coupled developments that have collectively changed the world. Around the globe, they have enhanced the lives of people of all walks of life and have spawned industry upon industry by connecting consumers with products. More recently with the development of social media products, people around the globe have access to real-time, inexpensive mass communication tools.

More recently, the internet and to a lesser extent, social media have been utilized by individuals to enhance their career. This can range from simple searches for job openings, to a person posting their resume for hiring professionals to possibly stumble upon, or to staying connected with professional connections via a social media-based digital rolodex. However, it is believed that the power of social media could be further harnessed in order to create a new career development opportunities.

### SUMMARY

The methods and systems disclosed herein provide for a novel way for people to utilize social media to expand their career development potential. In one embodiment, a person may begin by creating an online profile which may include relevant parts of their professional work history. In another embodiment, that person may then request that part or all of their work history be reviewed by former co-workers and/or supervisors. In a further embodiment, the person may then have the ability to preview any reviews of their work history received back from such co-workers and/or supervisors. In still another embodiment, the person may then determine which such reviews are representative, and therefore which reviews to publish with their work history. In another embodiment, a digital resume may be created which may combine the work history with received or published reviews. In a further embodiment, a digital resume may be associated with a status (e.g., bronze, silver, or gold), wherein the status may be based at least in part on the number of reviews which are utilized to create the digital resume. In still another embodiment, the user may then allow their digital resume to be searched for by potential human resource professionals.

It is therefore an advantage of the present disclosure to provide an interactive tool to allow people to create digital resumes.

It is another advantage of the present disclosure to allow people to request review of their prior work history.

It is a further advantage of the present disclosure to allow a user to have a level of control over who has access to reviews of the prior work history, which before had traditionally been exclusively controlled by their previous employers.

It is a further advantage of the present disclosure to create a digital resume that may be viewed as more objective as it may include review data from former co-workers and/or supervisors.

It is similarly an advantage of the present disclosure to provide a digital resume that may be searched for by human resource professionals.

It is another advantage of the present disclosure to provide a digital resume that may include a status.

It should be understood that various changes and modifications to the presently preferred embodiments described herein will be apparent to those skilled in the art. Such changes and modifications can be made without departing from the spirit and scope of the present subject matter and without diminishing its intended advantages.

### BRIEF DESCRIPTION OF THE FIGURES

FIG. 1 is a schematic drawing illustrating a network environment, in accordance with one embodiment of the present invention.

FIG. 2 is a schematic drawing illustrating software architecture, in accordance with one embodiment of the present invention.

FIG. 3 is a flow diagram for building a digital resume, according to one embodiment.

FIG. 4 is another flow diagram for building a digital resume, according to one embodiment.

FIG. 5 is a flow diagram for providing a review, according to one embodiment.

FIG. 6 is an exemplary digital resume, according to one embodiment.

FIG. 7 is an exemplary user interface for searching for digital resumes, according to one embodiment.

### DETAILED DESCRIPTION

A method, system, and computer-readable medium are described below which facilitates the building and/or verification of a digital resume. In particular, in some embodiments disclosed herein, a website is provided which allows a person to create a profile. In a further embodiment, the profile may include the relevant work history of that person. In another embodiment, the person may then request that part or all of their work history be reviewed by former co-workers and/or supervisors.

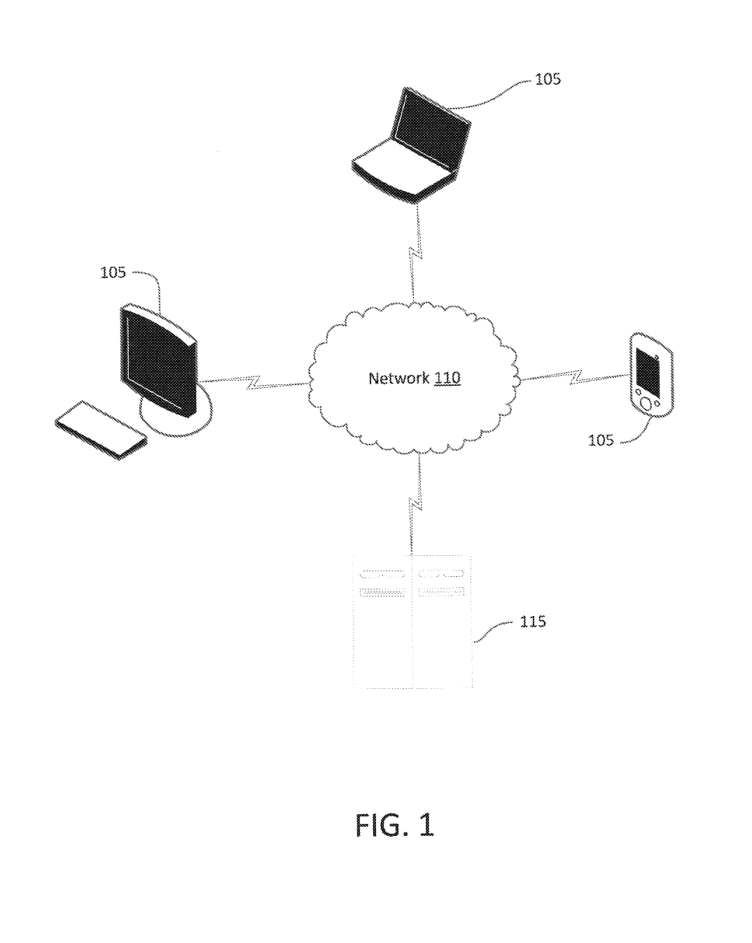

Referring to FIG. 1, a schematic drawing illustrating a network environment, in accordance with one embodiment of the present invention, is shown. Specifically, one or more user devices 105 may communicate over a network 110 with system servers 115.

The various user devices 105 may comprise desktop computers, laptop computers, tablet computers, e-readers, mobile/smart phones, gaming devices, personal digital assistants (pda's), televisions, and other network-enabled media display devices. Network 110 may comprise the internet, a cellular network, other similar area networks, or a combination thereof, and communication with various user devices 105 could be through a wireless or hardwire connection, or a mixture thereof. Further, it is contemplated that Network 110 may comprise intermediary servers (not shown), which may help accelerate the transfer of data between user devices 105 and system servers 115.

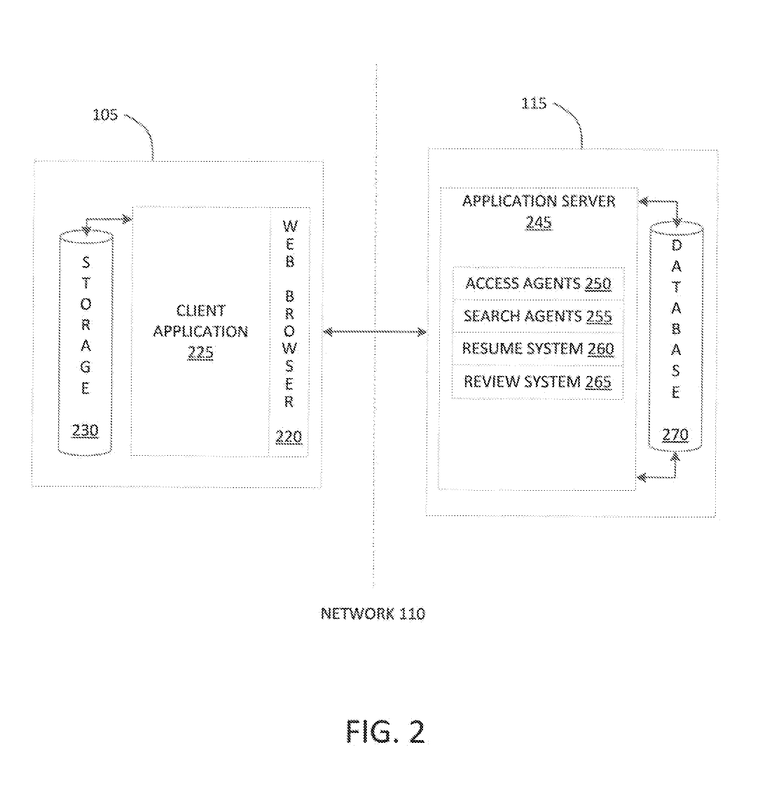

FIG. 2 is a schematic drawing illustrating software architecture, in accordance with one embodiment of the present invention. In one embodiment, a user device 105 may communicate, via network 110, with system servers 115. In another embodiment, user device 105 may include a web browser application 220, which may allow the user device 105 to access online resources. For example, network 110 may be the internet, and access to system servers 115 may be via the internet, and web browser application 220 may enable such communication. In another example, network 110 may be at least partially a cellular network, and access to system servers 115 may be at least partially via the cellular network, and web browser application 220 may be configured to include mobile browser functionality.

User device 105 may also include a client application 225, which may utilize web browser application 220. In one embodiment, the client application 225 may include further components which may facilitate the building of a digital resume and/or interfacing with a system website. In one example, client application may include a personal profile builder, and personal access agent, a personal search agent, a resume search agent, a resume builder, or a combination of one or more thereof. In one embodiment, web browser application 220 and client application 225 reside in, or are in communication with, one or more memory storage devices 230.

System servers 115 may include an application server 245, which may help manage web server functions (e.g., http requests, etc.). In one embodiment, application server may include various elements, such as access agents 250, search agents 255, resume system 260, and review system 265. Access agents 250 may help manage access to various portions of system servers 115. Search agents 255 may help manage various searches of system servers 115 made by various users. Resume system 260 may help manage the construction of a digital resume, as discussed more below. Review system 265 may help manage the review process, as discussed more below, associated with a digital resume. In one embodiment, application server 245 and/or one or more included elements may reside in, or are in communication with, one or more databases 270. In another embodiment, database 270 may provide storage for one or more processes associated with application server. In a further embodiment, database 270 may include data associated with one or more users of the system website.

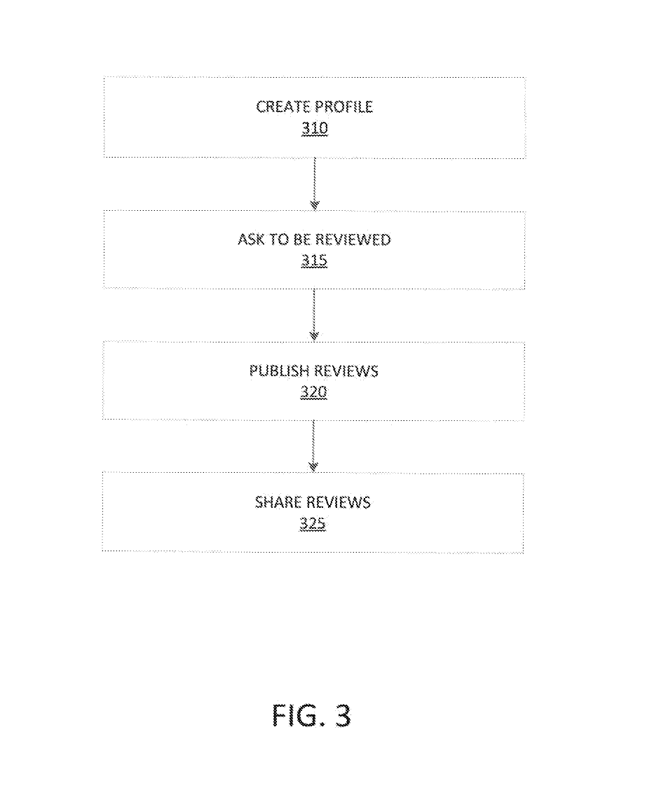

FIG. 3 is a flow diagram for building a digital resume, according to one embodiment. In this simplified example, a user would begin by creating a profile at step 310. In one embodiment, a profile may include personal data about the user, such as their name. In another embodiment, a profile may include some historical data related to the user, for example prior employment history, prior salary history, prior residences, prior names, education, certifications received, awards received, or a combination of one or more thereof. In a further embodiment, a profile may include subjective data, such as a user's goals, a user's self-evaluation of his or her skills or performance, or any other opinion a user may want to include.

At step 315, the user may request that part or all of their profile be reviewed. In one embodiment, the user may request that prior employment data included in the profile be reviewed by persons who worked with the user during that time. In another embodiment, a person being asked to review such employment history may simply be asked to confirm that the details included are generally accurate. For example, a reviewer may be asked to simply verify that Joe worked at ACME in 2006, or that Joe held the position of Line Manager in 2006. In another embodiment, a person being asked to review may be asked to provide a subjective review, which may include the reviewer's opinion on the user's performance of one or more aspects of their job. For example, a reviewer may be asked to rate Joe on various criteria as it relates to his time working at ACME. In another example, a reviewer may be asked to provide written opinions about the user.

In one embodiment, the user may be requested to provide contact information for potential reviewers. For example, the system may prompt the user to enter email addresses of former co-workers and/or supervisors who may provide reviews of the user's work history. In another embodiment, the system itself may be configured to suggest possible reviewers. For example, if Joe's profile includes that he worked at ACME in 2006, the system may access a database to determine other users who also aimed to work at ACME in 2006, and thereafter it may identify one or more of such other users as possible reviewers. In one embodiment, the user must approve each potential reviewer. It is contemplated that in this embodiment, the user may feel a sense of control over their profile. In another embodiment, the system may automatically select one or more potential reviewers and subsequently request a review. It is contemplated that in this embodiment, the subsequent reviews may have a perceived additional factor a reliability as the reviewers were not hand-selected by the user.

At step 320, received reviews are published. In one embodiment, the ac of publishing reviews may be utilized to update a created profile. For example, the publishing of a review may thereafter include at least a part of that review in a user's digital resume. In one embodiment, received reviews may be filtered by the user, with the user ultimately determining which reviews to include with their digital resume. In another embodiment, a user may have absolute control over which reviews get published. In another embodiment, the user may have a preset number of reviews that they can prevent from being published. For example, a user may have the ability to delete or otherwise not publish five received reviews. In another example, a user may have the ability to delete or otherwise not publish as number of reviews based on a number of allowed reviews. For example, a user may filter one received review for every five received reviews that they do allow to be published.

At step 325, the user next sets criteria for sharing reviews. In one embodiment, the step of sharing reviews may determine who has access to a user's profile and/or a user's digital resume. In another embodiment, a user may identify a category of people who do have access to their reviews. For example, a user may allow access to executive recruiters registered with the system website. In another embodiment, a user may identify a category of people who do not have access to their reviews. For example, a use may not allow access to employees from their current employer. In a further embodiment, a user may allow restricted access to their reviews. For example, a user may allow their work experience and associated reviews to be searchable and/or visible to other users, but not their personal information (e.g., name, address, etc.). In another example, a user may be asked to allow the release of their personal data to a third party. For example, headhunter may perform a search of digital resumes and associated reviews on the system website, and identifies a first digital resume as being a possible candidate for an open job, but does not know the personal details associated with the first digital resume. The headhunter may then need to send a request via the system website to determine such personal information. In a further example, the system website may then forward the request to the associated user and allow the user to determine whether or not to forward such personal data to the headhunter or otherwise grant further access to the user's profile.

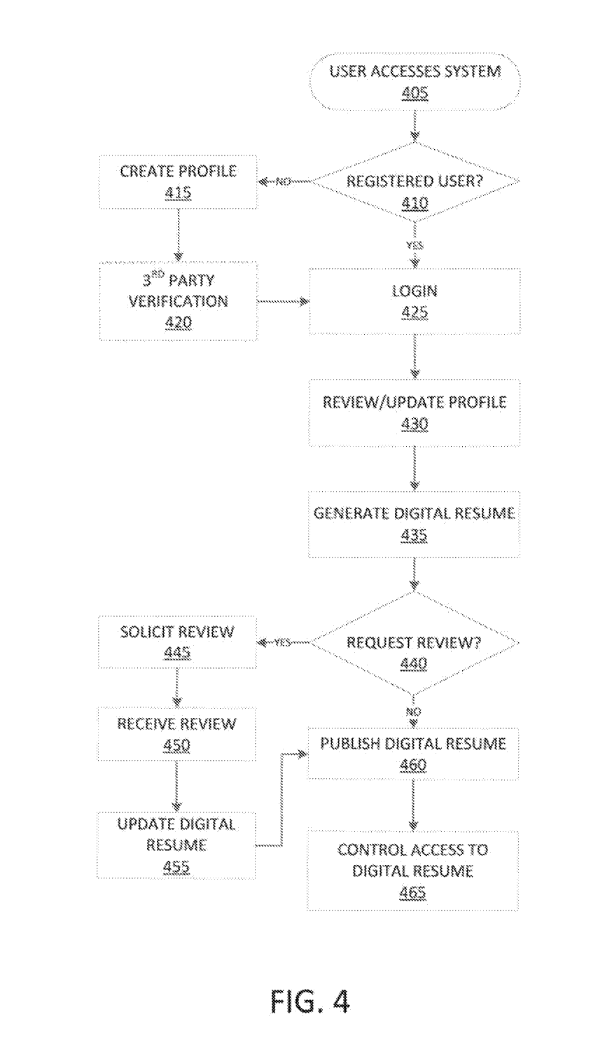

FIG. 4 is another flow diagram for building a digital resume, according to one embodiment. Specifically, FIG. 4 illustrates a system whereby a user may access the system and build a digital resume, according to one embodiment.

At step 405, a user accesses the system. In one embodiment, the user may utilize a user device which communicates via the internet to access a system website. At step 410, it is determined whether the user is a registered user or not. In one embodiment, the system may not allow any access unless the user is registered. In another embodiment, the user may be allowed to access portions of the system without having to register. For example, the user may be able to search general information from digital resumes from the system website, but may not be able to ascertain specific data about any one digital resume, without first registering with the system.

If the user is not a registered user, they may then create a profile at step 415. As discussed above, creating a profile may include various aspects of the user's personal and/or historical information. In one embodiment, a profile may include relevant work history associated with the user. In another embodiment, a user's profile would include all the data that a person might include on a traditional resume. In a further embodiment a user's profile may also include current contact information, as well as a username and password for accessing the system. It is contemplated that in one or more embodiments, a profile may include a user's name, email address, job titles, job levels, companies having worked for, associated dates, industry, work region, a user's image, listing of key compensation information, and/or a combination of one or more thereof.

Step 420 is shown in dashed form as this step may only be included in select embodiments. Specifically, at step 420, a user's profile may be verified by one or more 3^{rd} parties. It is contemplated that in one embodiment, requiring 3^{rd} party verification of a user's profile before allowing access to the system may create a more trusted service. Specifically, it is contemplated that parties that may use the system to locate potential employees may consider the data provided more reliable if they know that there has been at least some level of authentication performed on the data.

In one embodiment, a system may perform a 3^{rd} party verification by communicating with other registered users that share similar work histories. For example, if Joe indicated that he worked at ACME from 2006 to 2008, the system may be configured to identify other registered users that worked at ACME during that time period, and communicate with them and request that they authenticate whether or not Joe actually worked at ACME during that time period. In another embodiment, a system may allow the user to identify potential 3^{rd} parties that may be able to verify the user's work history. In another example, the system may send out, or otherwise cause to be sent out, a short questionnaire which attempts to ascertain whether Joe worked at ACME during that time period, as well as what kind of employee Joe was.

In another embodiment, the system may communicate directly with former employers and request such employment verification. In one example, the system may cause a message to be sent to a company representative, such as a Human Resources representative, to request verification of a person's prior employment. In another example, the sent message may request that the company representative login into the system website to provide such verification. In a further example, the system website may request that the company representative answer one or more questions about the alleged former employee. In still another example, the system website may indicate that if the company or company representative is not a registered user of the system website, that in return for the verification and/or review of the alleged former employee, the company or company representative may receive a promotional offer, such as additional functionality from the system website, a reduced fee to access the system website, or any of a number of well-known promotional offers.

In a further embodiment, the system may utilize an employment verification service. For example, an employment verification service may be a business that is independent of the owners and/or operators of the system, and is independent of the former employers that are being queried, but they have agreed to act as an intermediary between the system and the former employers to verified alleged employment histories.

In another embodiment, the system may assign a verification score based on the number of verifications received. For example, if the system receives a plurality of verifications that Joe worked at ACME, that element of Joe's profile may be given a higher verification score than another portion that received fewer such verifications. In a further embodiment, the system may assign a verification score based on who provides the verifications. For example, a user's work history may be associated with a higher verification score if it was verified by one or more system users who have higher associated statuses vs. having been verified by one or more system users who have lower associated statuses. It is contemplated that providing a verification ranking may be considered particularly useful in assisting potential searchers identity quality candidates for open employment positions. In another embodiment, the system may prevent a digital resume (as discussed in more detail below) from being accessed by a third party until the associated work history is associated with a prerequisite verification score.

In another embodiment, the system may verify a person's prior employment in one or more stages. For example, if Joe identifies three companies that he used to work for, the system may begin verifying such employment history, but it is very possible that one or more of such companies may take longer to verify than another of the companies. In one such example, the system may cause the profile to be provisionally accepted. In another such example, the system may graphically indicate that the profile is provisionally accepted to other users who may view part or all of the profile or associated digital resume. In a further example, the system may associate as verification score individually with each of any identified prior employments. In still another example, the system may associate an overall verification score to a user's prior employment history. In another example, the overall verification score may be lower if not all of a user's prior employment history has been verified.

At step 425, the user may be able to login. In one embodiment, the user may utilize a username and password they created during the step 415 to login. The user may then be allowed to review and/or update their profile at step 430. In one embodiment, the user may be allowed to edit prior profile data they may have inputted into the system. In another embodiment, the user may be allowed add additional information to their profile. For example, the user may be able to add specific skill sets the person has competency in. In another example, the user may be able to add a new job and/or responsibility change. It is contemplated that a user may want to periodically review and update their profile for various personal and/or professional reasons.

At step 435, the system may generate a digital resume. In one embodiment, the digital resume is automatically generated by the system based on the user's profile. In another embodiment, the digital resume may include information derived from a 3^{rd} party. For example, the digital resume may include a 3^{rd} party verification status (e.g., from step 420) or information from a review provided by a 3^{rd} party (e.g., from steps 445 to 455, discussed more below). In a further embodiment, a user may have limited control over the appearance of a digital resume. For example, the system may be configured to automatically generate digital resumes, based on a user's profile, and to generate each such digital resume in a similar format as each other resume. It is contemplated that some users of the system may prefer that all such generated digital resumes have a similar appearance so that the resumes may be judged on substance vs. form or appearance. In another embodiment, the system may allow a user to customize one or more attributes of the appearance of their digital resume. For example, a user may be allowed to select the font of their resume. In another example, a user may be allowed to select a background color or watermark for their digital resume. It should be appreciated that there are numerous ways that a user may be allowed to personalize the appearance of a digital resume, and all such ways are herein contemplated.

At step 440, the user may be allowed to request review of one or more data points. In one embodiment, the review may be similar to step 420. In another embodiment, requesting a review may supplant step 420. For example, a review by a former co-worker of Joe's management style while Joe was employed at ACME may also be utilized to verify the inherent fact that Joe in fact worked at ACME. In another embodiment, a requested review may be limited to less than all employment history associated with a user profile. For example, a user may request reviews pertaining to his or her last employment, but may not request review for employment history prior to that. It is contemplated that user may be allowed to selectively request reviews for specific aspects of their employment history, and that such allowed specificity may be a desirable feature as it may both highlight specific history that a user desires to be emphasized, and minimize the apparent importance of other history, thereby giving a level of control over the digital resume by the user.

If a user does indicate that they want to request a review at step 440, the system may then solicit one or more reviews at step 445. In one embodiment, the system may first allow a user to identify certain parameters applicable to such solicited review. For example, a user may be allowed to identify the portion of their profile and/or digital resume that is being subject to review. In another example, the user may be allowed to identify one or more individuals that such review is to be sought. For example, the user may input an email address or other contact information for a former co-worker that the user wants to provide a review. In another embodiment, the system may be configured to automatically identify other system users that may be able to provide a knowledgeable review of the user's work history. In one example, the system may be able to determine that Jane, a registered user, worked at ACME during part or all of the time that Joe worked at ACME. In another example, the system may recommend Jane as a possible reviewer. In a further example, the system may automatically request a review by Jane without an explicit request by Joe to do so.

In one embodiment, the solicited review may ask a potential reviewer to visit the system website to provide such a review. For example, the solicited review may be in the form of an email, with a link the system website. In another embodiment, a reviewer may need to be a registered user in order to provide a review. For example, a potential review may need to login to the system (e.g., step 425) in order to provide a review. In another example, a potential reviewer may need to first register with the system (e.g., step 415) before being allowed to provide a review. In a further example, the potential reviewer may be provided a promotional offer in return for such login, registration, and/or providing the requested review.

In one embodiment, the form of the requested review includes standardized elements. For example, the form of the requested review may request that the reviewer rank the user on a scale (e.g., from one to five, five being more favorable than one) on a plurality of questions and/or criteria. In a more specific example, the form of the review may ask the reviewer to rank Joe, on a scale from one to five, on his productivity. In another embodiment, the form of the requested review may include one or more freestyle elements. For example, the review may ask the reviewer to provide a one-sentence summary of Joe in the reviewer's own words. It is contemplated that historical employee reviews have been greatly varied, and that a system operator may utilize various components of such historical reviews in accordance with the disclosure herein, without varying from the scope of the present invention. It is additionally contemplated that requesting and subsequently receiving a review of a user's prior work history is substantially different than a user receiving an endorsement or recommendation by a former co-worker, as a review provides a more job-specific gradation.

In one embodiment, the requested review may include one or more questions regarding the reviewer. For example, the requested review may attempt to ascertain whether the reviewer with the user, for the user, if the user worked for the reviewer, if the reviewer was a client of the user, if the user was a client of the reviewer, if the reviewer currently works with (or for, or as a manager of, etc.) the user, or any combination thereof. In another embodiment, the requested review may include one or more questions related to a user's competency or competencies, reliability, ethics, integrity, people skills, pressure management, specific skill sets as identified by the user, specific skill sets as identified by the requested reviewer, other specific skill sets, or a combination of one or more thereof.

In a further embodiment, the requested review may include one or more questions which attempt to ascertain a normalization that should be applied to the review itself. In one example, the requested review may include a standardized to try and ascertain general tendencies of a reviewer, such as a question asking how the reviewer would rate an all-around good performer. In this example, the responses received from numerous different reviewers may be utilized to determine a normalization routine to apply to such reviews. For example, if a first reviewer respond to such a question with a “2 out of 5” ranking, and a second reviewer responds with a “5 out of 5” ranking, the system may characterize reviews from the first reviewer as tending to be lower and may then artificially inflate such reviews, and/or may characterize reviews from the second reviewer as tending to be higher and may artificially lower such reviews.

In another embodiment, the system may be configured to determine a normalization to apply to reviews based on historical review data provided by one or more reviewer. For example, the system may be configured to determine one or more reviews provided by a first reviewer, and compare them to other reviews received for the same users. From such analysis the system may be able to determine tendencies of the reviewer, e.g., whether they tend to review higher than other reviewers or lower than other reviewer, and the system may then artificially normalize, based on such analysis, one or more reviews from the first reviewer. For example, if the first reviewer generally ranked users lower than the average of all other reviewers, the system may be configured to normalize one or more reviews received by the first reviewer by artificially increasing at least a part of its score or ranking. Such normalization may be performed on a question by question basis, or on an overall review by review basis.

At step 450, the system may receive provided reviews. In one embodiment, the reviews are received directly from the reviewer. For example, the reviewer may have provided the information directly to the system website. In another example, the reviewer may have provided the information into a computer application attached or otherwise associated with the initial review request, and may have simply “returned” the communication which may then automatically forward the review to the system. In another embodiment, the review is received from an unrelated 3^{rd} party. For example, the requested review may direct the reviewer to a 3^{rd} party website, and that 3^{rd} party may subsequently forward part or all of any provided review to the system website.

At step 455, the digital resume may be updated based on one or more received reviews. In one embodiment, prior to updating the digital resume, the user may be allowed to examine the review. In one example, the user may be allowed to reject, or otherwise prevent the updating of the digital resume based on, part or all of the received reviews. In another example, the user may be allowed such control over all received reviews. In a different example, the user may be allowed such control over some, but less than all received reviews. In a more specific example, a user may be allowed to reject one received review for every four received reviews that they do not reject. In another embodiment, the user is not allowed to filter part or all of any received reviews. For example, in one embodiment, the user may be allowed to control who provides a review, but then may not be able to filter how the received review is applied to their digital resume.

In another embodiment, the system may apply an automatic normalization algorithm to one or more elements of received reviews and/or one or more received reviews in their entirety. For example, the system may automatically remove, or otherwise prevent from updating the digital resume, the highest and lowest overall reviews. In another example, the system may filter the highest and lowest score for each review category. In another example, the system may filter out a review that is outside a standard deviation from other received reviews. In still another example, the system may filter out part or all of a review based on the date of the review and/or the date of the associated employment history. It is contemplated that several normalization methodologies may be adequately applied, and each one should be considered within the scope of the present disclosure.

In one embodiment, once the digital resume is updated at step 455, or a review was not requested at step 440, the system may then publish the digital resume at step 460. In one embodiment, a published digital resume is only viewable by the user. In another embodiment, the user may be allowed to print or otherwise share a physical copy of the digital resume. In a further embodiment, step 460 allows the user to review the information and/or appearance of their digital resume, before allowing other people to access the digital resume. In a further embodiment, a published digital resume may be selectively viewable by other users. For example, the system website may allow a user to have a limited number of other users view his digital resume in order to provide input on its appearance and/or content. In another embodiment, the system may be configured to automatically provide suggestions to the user to modifying the published digital resume. For example, the system may recommend that the user identify one or more reasons for a gap in their work history. It is contemplated that at step 460, the added step of reviewing the digital resume may be considered particularly useful by some users as it may prevent a potentially embarrassing gaffe.

At step 465, the system may determine who has access to what parts of the digital resume. In one embodiment, the user may have control over who has access to search and/or view their digital resume. In another embodiment, the user may have control over who has access to search and/or view certain elements of their digital resume. In a further embodiment, the system may be preconfigured to determine who has access to search and/or view the published digital resume. It is contemplated that providing one or more user-configurable control features may be perceived as particularly beneficial, as then users may be more likely to utilize the system if they can at least partially control who can view their digital resume.

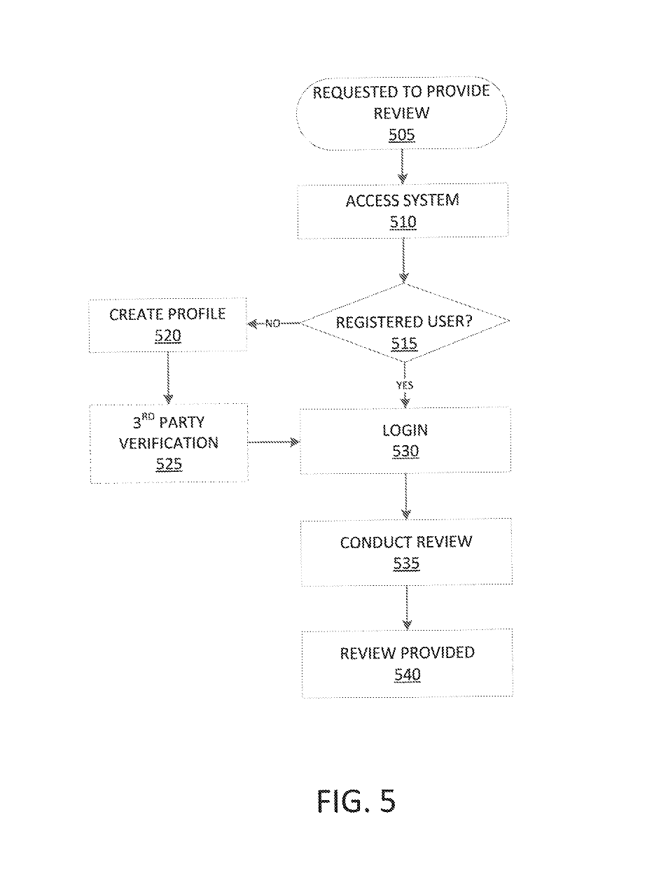

FIG. 5 is a flow diagram for providing a review, according to one embodiment. In one embodiment, a potential reviewer is required to access the system website in order to provide a review. It is contemplated that in such an embodiment, it may be particularly beneficial to require potential reviewers to register with the system as a means for growing system users.

At step 505, a potential reviewer receives a request to provide a review. In one embodiment, the potential reviewer may receive an email notification or other form of electronic communication. For example, the potential reviewer may receive an email notification with a link to the system website. In another embodiment, the potential reviewer may receive a communication from a system website messaging system. For example, if the system website provided all registered users a system-specific way to communicate directly with each other, the system may utilize such system to request a review.

At step 510, a requested reviewer accesses the system. In one embodiment, the requested reviewer may utilize a user device which communicates via the internet to access a system website. At step 515, it is determined whether the requested reviewer is a registered user or not. In one embodiment, the system may not allow any access unless the user is registered. In another embodiment, the user may be allowed to access portions of the system without having to register. For example, the user may be able to search general information from digital resumes from the system website, but may not be able to ascertain specific data about any one digital resume, without first registering with the system.

If the requested reviewer is not a registered user, they may then create a profile at step 520 to become a registered user. As discussed above, creating a profile may include various aspects of the user's personal and/or historical information. In one embodiment, a profile may include relevant work history associated with the user. In another embodiment, a user's profile would include all the data that a person might include on a traditional resume. In a further embodiment, a user's profile may also include current contact information, as well as a username and password for accessing the system. It is contemplated that in one or more embodiments, a profile may include a user's name, email address, job titles, job levels, companies having worked for, associated dates, industry, work region, a user's image, listing of key skills, compensation information, and/or a combination of one or more thereof.

Step 525 is shown in dashed form as this step may only be included in select embodiments. Specifically, at step 525, a user's profile may be verified by one or more parties. It is contemplated that in one embodiment, requiring party verification of a user's profile before allowing access to the system may create a more trusted service. Specifically, it is contemplated that parties that may use the system to locate potential employees may consider the data provided more reliable if they know that there has been at least some level of authentication performed on the data.

In one embodiment, a system may perform a 3^{rd} party verification by communicating with other registered users that share similar work histories. For example, if Joe indicated that he worked at ACME from 2006 to 2008, the system may be configured to identify other registered users that worked at ACME during that time period, and communicate with them and request that they authenticate whether or not Joe actually worked at ACME during that time period. In another example, the system may send out, or otherwise cause to be sent out, a short questionnaire which attempts to ascertain whether Joe worked at ACME during that time period, as well as what kind of employee Joe was.

In another embodiment, the system may communicate directly with former employers and request such employment verification. In one example, the system may cause a message to be sent to a company representative, such as a Human Resources representative, to request verification of a person's prior employment. In another example, the sent message may request that the company representative login into the system website to provide such verification. In a further example, the system website may request that the company representative answer one or more questions about the alleged former employee. In still another example, the system website may indicate that if the company or company representative is not a registered user of the system website, that in return for the verification and/or review of the alleged former employee, the company or company representative may receive a promotional offer, such as additional functionality from the system website, a reduced fee to access the system website, or any of a number of well-known promotional offers.

In a further embodiment, the system may utilize an employment verification service. For example, an employment verification service may be a business that is independent of the owners and/or operators of the system, and is independent of the former employers that are being queried, but they have agreed to act as an intermediary between the system and the former employers to verified alleged employment histories.

In another embodiment, the system may verify a person's prior employment in one or more stages. For example, if Joe identifies three companies that he used to work for, the system may begin verifying such employment history, but it is very possible that one or more of such companies may take longer to verify than another of the companies. In one such example, the system may cause the profile to be provisionally accepted, in another such example, the system may graphically indicate that the profile is provisionally accepted to other users who may view part or all of the profile.

At step 530, the user may be able to login. In one embodiment, the user may utilize a username and password they created during the step 520 to login. The user may then be allowed to conduct the requested review at step 535. In one embodiment, the form of the requested review includes standardized elements. For example, the form of the requested review may request that the reviewer rank the user on a scale (e.g., from one to five, five being more favorable than one) on a plurality of questions and/or criteria. In a more specific example, the form of the review may ask the reviewer to rank Joe, on a scale from one to five, on his productivity. In another embodiment, the form of the requested review may include one or more freestyle elements. For example, the review may ask the reviewer to provide a one-sentence summary of Joe. It is contemplated that historical employee reviews have been greatly varied, and that a system operator may utilize various components of such historical reviews in accordance with the disclosure herein, without varying from the scope of the present invention.

In one embodiment, the requested review may include one or more questions regarding the reviewer. For example, the requested review may attempt to ascertain whether the reviewer with the user, for the user, if the user worked for the reviewer, if the reviewer was a client of the user, if the user was a client of the reviewer, if the reviewer currently works with (or for, or as a manager of, etc.) the user, or any combination thereof. In another embodiment, the requested review may include one or more questions related to a user's competency or competencies, reliability, ethics, integrity, people skills, pressure management, specific skill sets as identified by the user, specific skill sets as identified by the requested reviewer, other specific skill sets, or a combination of one or more thereof.

In a further embodiment, the requested review may include one or more questions which attempt to ascertain a normalization that should be applied to the review itself. In one example, the requested review may include a standardized to try and ascertain general tendencies of a reviewer, such as a question asking how the reviewer would rate an all-around good performer. In this example, the responses received from numerous different reviewers may be utilized to determine a normalization routine to apply to such reviews. For example, if a first reviewer respond to such a question with a “2 out of 5” ranking, and a second reviewer responds with a “5 out of 5” ranking, the system may characterize reviews from the first reviewer as tending to be lower and may then artificially inflate such reviews, and/or may characterize reviews from the second reviewer as tending to be higher and may artificially lower such reviews.

In another embodiment, the system may be configured to determine a normalization to apply to reviews based on historical review data provided by one or more reviewer. For example, the system may be configured to determine one or more reviews provided by a first reviewer, and compare them to other reviews received for the same users. From such analysis, the system may be able to determine tendencies of the reviewer, e.g., whether they tend to review higher than other reviewers or lower than other reviewer, and the system may then artificially normalize, based on such analysis, one or more reviews from the first reviewer. For example, if the first reviewer generally ranked users lower than the average of all other reviewers, the system may be configured to normalize one or more reviews received by the first reviewer by artificially increasing at least a part of its score or ranking. Such normalization may be performed on a question by question basis, or on an overall review by review basis.

At step 540, the system may allow the reviewer to provide the review. In one embodiment, the system is configured to allow the reviewer to inspect one or more elements of their proposed review prior to formally providing the review. In another embodiment, the reviewer may be incentivized to provide such a review. For example, a status associated with the reviewers own digital resume may be affected by the number of reviews they provide. In another example, a status associated with the reviewers own digital resume may be affected by the time from when they were requested to provide a review to the time they did provide such a review. In another example, the reviewer may be provided with special access to one or more parts of the system based on criteria associated with them providing a review. In another example, the reviewer may be provided with a monetary benefit for providing a review.

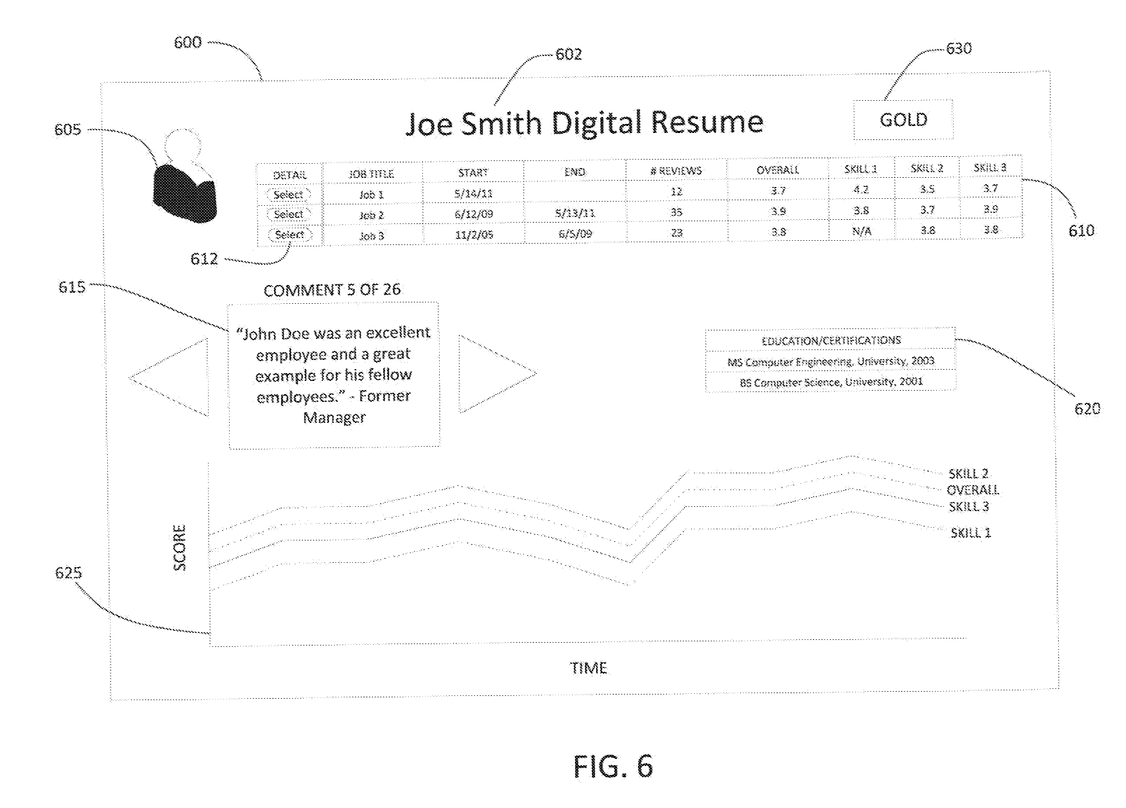

FIG. 6 is an exemplary digital resume, according to one embodiment. Specifically, FIG. 6 illustrates how a digital resume, generally shown at 600, may appear. In the present embodiment, digital resume 600 may include a personalized identifier 602. For example, a personalized identifier may simply be the user's name (e.g., Joe Smith). In another embodiment, a personal identifier 602 may include more information beyond a user's name. In another embodiment, personal identifier 602 may be completely customizable by a user, and may not even include the user's legal name. In a further embodiment, personal identifier 602 may be automatically generated based on a user's verified profile.

Digital resume 600 may also include a user icon 605. In one embodiment, a user icon 605 may be a picture of the user. In another embodiment, user icon 605 may be another image. For example, user icon 609 may be a graphical representation of the user, but not an actual picture of the user. In another embodiment, the user may be allowed broad flexibility in determining a user icon 605. In another embodiment, the system may only allow actual pictures of the user to be utilized as a user icon 605.

Digital resume 600 may also include a user's work history summary 610. In the present example, work history summary 610 includes the user's job title, their start and end dates at each job, the number of reviews they have received for each listed job, their average review score for each of three identified skills (e.g., Skill 1, Skill 2, and Skill 3) and their overall average review score for each job. Work history summary 610 may also include one or more detail hyperlinks 612 which may allow a viewer to access more detail related to one or more identified jobs and/or associated reviews. In one embodiment, work history summary 610 may only include factual data, such as job titles and associated dates.

Digital resume 600 may also include reviewer quotes 615. In one embodiment, digital resume 600 may allow a viewer to access a plurality of reviewer quotes (e.g. by use of the forward or back inputs shown in exemplary form). It is contemplated that it may be considered particularly useful to allow access to freeform quotes in addition to standardized reviews, as they may be able to provide insight not otherwise available from a standardized ranking system.

Digital resume 600 may also include an education summary 620. In one embodiment, education summary 620 may also include certifications that the user has obtained. It is contemplated that some industries may not place as significant of emphasis on education as other industries, and therefore in some embodiments education summary 620 may not be included or otherwise initially viewable from the default digital resume 600.

Digital resume 600 may also include a graphical review summary 625. In the present example, graphical review summary 625 may include line graphs which illustrate the historical progression of the user's work experience and applicable reviews at various skills, which may reference specific job skills (e.g., Java programming, etc.) or may reference general user traits (e.g., courteousness, etc.), as well as the user's overall review score. In a further embodiment, graphical review summary 625 may also incorporate a graphical element associated with the number of reviews which are utilized to generate the associated graphics.

In FIG. 6, graphical review summary 625 is illustrated as a line graph, but it is expressly contemplated that there are various ways to graphically illustrate a summary of the received and/or applied reviews, and that a plurality of such ways are dependent on the format of the received review itself, and all such ways are to be included as contemplated herein. It is further contemplated that in some embodiments, the combination of the work history summary 610 and graphical review summary 625 may be considered particularly useful as they may combine to provide an easily discernible yet objectively validated resume.

In one embodiment, a viewer of the digital resume 600 may be allowed to customize how the graphical review summary 625 is displayed. For example, a viewer might be allowed to select the data points utilized for one or more axis of graphical review summary 625 (e.g., only illustrate the last five years of employment history and associated review scores along the “TIME” axis). In another embodiment, a viewer may be allowed to add a viewer-defined graphical feature to the graphical review summary 625. For example, a viewer may be allowed to overlay a minimal review score line on graphical review summary 625, which may help the reviewer to quickly sort through a plurality of digital resumes.

Digital resume 600 may also include a resume status 630. In one embodiment, resume status 630 may be selected from a predetermined number of status levels (e.g., bronze, silver, gold, and platinum). In another embodiment, resume status 630 may include a numerical indicator. In a further embodiment, resume status 630 is based at least in part on the number of reviews that are incorporated into the digital resume 600. In another embodiment, resume status 630 is based at least in part on the number of received reviews that are excluded from or otherwise filtered from being incorporated into the digital resume 600. In a further embodiment, resume status 630 is based at least in part on the number of reviews that are incorporated into the digital resume over a preset amount of time. For example, in order to maintain a Gold status, a user may need to incorporate at least five reviews within the previous six months. In another example, if a user does not achieve the prerequisite amount of reviews within the present time period, the resume status 630 may decrease. It is contemplated that including a time function for determining a resume status 630 may be considered particularly beneficial as it may help incentivize users to continually seek reviews of their performance, which in turn may help ensure that the digital resume itself is more relevant. It is also contemplated that a resume status 630 itself may be particularly beneficial as well as it may provide a quick reference for viewers as to the accuracy and/or freshness of the digital resume 600.

While the digital resume 600 illustrated in FIG. 6 is only an exemplary embodiment, several advantages should be readily apparent. It is contemplated that the combination of some historical factual information (e.g., work history summary 610), performance review data (e.g., graphical review summary 625), and a credibility ranking (e.g., resume status 630) may be considered particularly beneficial and may be perceived as more objective than traditional resumes, which are by their nature very subjective. In this sense, it is contemplated that a reviewer of such digital resumes may be able to more equally compare one resume to another on an “apple to apple” basis without distractions that different forms of resumes can often include.

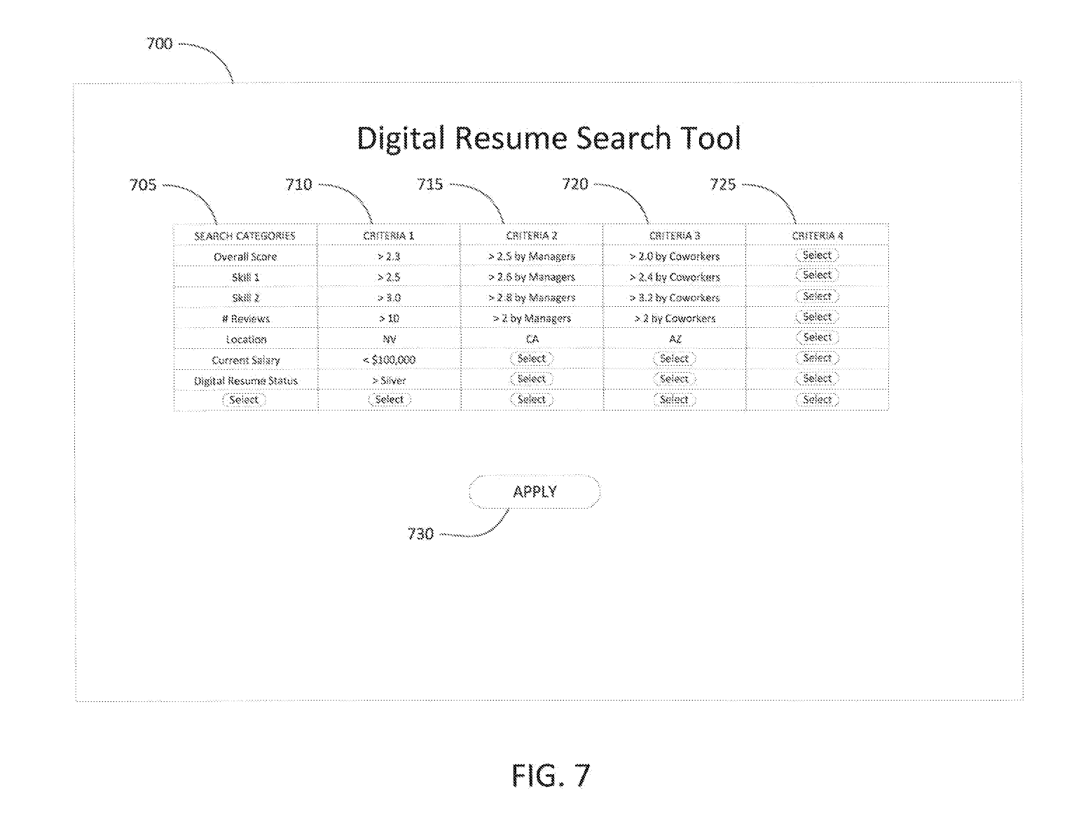

FIG. 7 is an exemplary user interface for searching for digital resumes, according to one embodiment. Specifically, FIG. 7 illustrates an exemplary search interface 700. In one embodiment, all registered users of the system may utilize search interface 700 to search for digital resumes stored by the system. In another embodiment, special access is required to utilize search interface 700. For example, the system operator (e.g., system website owner) may charge a fee for such access. In another embodiment, all registered users may have access to less than all search interface 700 functionality, and a user must further request and/or register from more such searching access.

The present example includes a listing of search categories at 705, which may allow a user to select from a plurality of predefined categories, and a plurality of applied criteria (e.g., 710-725). In another embodiment, search categories and/or criteria may include the ability to customize terms. As generally illustrated by the various “Select' buttons in FIG. 7, in one embodiment a searcher may be able to select from a plurality of predefined search terms and/or criteria. It is contemplated that it may be particularly beneficial to provide a search interface 700 which may allow a searcher to be very specific in the digital resumes they are filtering through.

In a further embodiment, a searcher may then select the apply button 730, which may cause the search to be executed. In another embodiment, executing such a search may also determine one or more aspects of how responsive digital resumes are illustrated to the searcher. For example, the identified search categories 705 from a specific search may cause the illustrated digital resumes to include one or more such search categories in their graphical review summary (e.g., graphical review summary 625 from FIG. 6). In another example, the identified criteria (e.g., 710-725) may cause the illustrated digital resumes to include one or more such criteria in their graphical review summary.

In another embodiment, a searcher may utilize search interface 700 to initiate a search, and a results page may include a plurality of relevant digital resumes (e.g., digital resume 600 from FIG. 6). It is contemplated that it may be particularly useful to allow a searcher to sort through a plurality of similarly-formatted digital resumes, as the reviewer may find it easier to compare substance to substance, without possibly being distracted by differences in form. It is further contemplated that it may be particularly useful to allow a searcher to sort through a plurality of digital resumes that include relevant graphical summaries (e.g. graphical review summary 625 from FIG. 6), as it may help expedite what has traditionally been a time and labor-intensive process.

In one embodiment, a method of creating a digital resume includes receiving a first electronic communication from a first user device, wherein said received first communication includes first data associated with an employment history of a first person. In another embodiment, the method may continue us causing a second electronic communication to be sent to a second user device, wherein said sent second communication requests that a second person provide a review of the first data. In a further embodiment, the method may further cause a third electronic communication to be sent to a third user device, wherein said sent third communication requests that a third person provide a review of the first person. In still another embodiment, a computer system may receive a fourth electronic communication from the second user device, wherein said received fourth communication includes second data associated with the employment history of the first person. In another embodiment a computer-implemented method may receive a fifth electronic communication from the third user device, wherein said received fifth communication includes third data associated with the employment history of the first person. In a further embodiment, the second data may be modified, and thereafter a digital resume may be generated, wherein the digital resume includes the first data, the modified second data, and the third data. The digital resume may then be caused to be displayed on a fourth user device.

In another embodiment, computer-implemented method of creating a digital resume may comprise receiving historical employment data from a user and requesting a first reviewer to provide a first review on some but not all of the received historical employment data, and requesting a second reviewer to provide a second review on some but not all of the received historical employment data. In another embodiment, a system may be configured to receive the first and second reviews, and may generate a digital resume wherein the digital resume includes the received historical employment data, the first review, and the second review. In another embodiment, a method may further include determining a status of the digital resume, wherein the status is based at least in part of when the first and second reviews were received, and allowing the digital resume to be identified by a computer search query.

In a further embodiment, a system may be configured to receive historical employment data from a user, first data associated with a review of the user by a first reviewer, and second data associated with a review of the user by a second reviewer. In another embodiment, the system may be further configured to determine as work history verification score based at least in part on the received first and second data, and generate a digital resume wherein the digital resume includes the received historical employment data and a graphical representation of the received first and second data. In still another embodiment, the system may be configured to, when the work history verification score satisfies a predetermined criteria, cause the digital resume to be displayed on a user device.

Reference throughout this specification to “one example,” “an example,” “embodiment,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

The invention is claimed as follows:

1. A method of creating a digital resume, said method comprising:
receiving a first electronic communication from a first user device, wherein said received first communication includes first data associated with an employment history of a first person;
causing a second electronic communication to be sent to a second user device, wherein said sent second communication requests that a second person provide a review of the first data;
causing a third electronic communication to be seat to a third user device, wherein said sent third communication requests that a third person provide a review of the first person;
receiving a fourth electronic communication from the second user device, wherein said received fourth communication includes second data associated with the employment history of the first person;
receiving a fifth electronic communication from the third user device, wherein said received fifth communication includes third data associated with the employment history of the first person;
modifying the second data;
generating a digital resume, wherein the digital resume includes the first data, the modified second data, and the third data; and
causing the digital resume to be displayed on a fourth user device.

2. The method of claim 1, further comprising:
determining a status associated with the digital resume; and
causing the status to be displayed in association with the digital resume.

3. The method of claim 2, wherein the status is based at least in part on when the fourth and fifth communications were received.

4. The method of claim 3, wherein the status is further based at least in part on when the digital resume is caused to be displayed.

5. The method of claim 1, wherein the modified second data and the third data are caused to be displayed in a graphical form.

6. The method of claim 5, wherein graphical form is a graph.

7. A computer-implemented method of creating a digital resume, said method comprising:
receiving historical employment data from a user;
requesting a first reviewer to provide a first review on some but not all of the received historical employment data;
receiving the first review;
requesting a second reviewer to provide a second review on some but not all of the received historical employment data;
receiving the second review;
generating a digital resume wherein the digital resume includes the received historical employment data, the first review, and the second review;
determining a status of the digital resume, wherein the status is based at least in part of when the first and second reviews were received;
allowing the digital resume to be identified by a computer search query; and
causing a display device associated with the computer which initiated the computer search query to display the digital resume and the status.

8. The method of claim 7, wherein the status is further based at least in part on when the digital resume is caused to be displayed.

9. The method of claim 7, wherein the first review and second review are represented in graphical form on the digital resume.

10. The method of claim 7, wherein at least a portion of the first review is modified prior to including it with the generated digital resume.

11. The method of claim 7, wherein the first review includes a ranking of a personal attribute of the user by the first reviewer.

12. The method of claim 7, wherein the first review includes written text.

13. The method of claim 7, wherein the computer search query does not include the name of the user.

14. The method of claim 13, wherein the computer search does not further include the name of any prior employers of the user.

15. A computer-implemented method of creating a digital resume, said method comprising:
receiving historical employment data from a user;
receiving first data associated with a review of the user by a first reviewer;
receiving second data associated with a review of the user by a second reviewer;
determining a work history verification score based at least in part on the received first and second data,
generating a digital resume wherein the digital resume includes the received historical employment data and a graphical representation of the received first and second data; and
when the work history verification score satisfies a predetermined criteria, causing the digital resume to be displayed on a user device.

16. The method of claim 15, wherein the work history verification score is further based on the identities of the first and second reviewers.

17. The method of claim 15, wherein the graphical representation modifies some but not all of data first data.

18. The method of claim 17, wherein the graphical representation is a graph, and a data point of the graph is based at least in part of the second data and the modified portion of the first data.

19. The method of claim 17, wherein the first and second data each include a ranking of a personal attribute of the user.

20. The method of claim 15, wherein the work history verification score is caused to be displayed in association with the displayer digital resume.
